(19) United States
(12) Patent Application Publication
(10) Pub. No.: US 2023/0368189 A1
(43) Pub. Date: Nov. 16, 2023

(54) SYSTEM AND METHOD FOR PURCHASING CUSTOMIZED NON-FUNGIBLE TOKENS

(71) Applicant: John Sebastian Ambrose, New York, NY (US)

(72) Inventor: John Sebastian Ambrose, New York, NY (US)

(21) Appl. No.: 17/663,030

(22) Filed: May 12, 2022

(51) Int. Cl. G06Q 20/38; G06Q 20/12; G06Q 10/02; H04L 9/00; G06Q 30/06

(52) U.S. Cl. CPC G06Q 20/38215; G06Q 20/1235; G06Q 10/02; H04L 9/50; G06Q 30/0641

(57) ABSTRACT

A computer-implement system and method for purchasing a non-fungible token (NFT) of a specific event or item is disclosed. The system comprises a processor and a memory unit to store a set of instructions executable by the processor, a database to store a plurality of data associated with the customized NFT, and a user device to provide a digital marketplace that provides graphical user interface. The system sells NFTs related to specific events or items in real-time. The NFTs act as an access pass or voucher. The system directs the customer towards an NFT marketplace via a QR code or an inaudible tone, where the customer purchases or sells the NFT to provide access to the specific event or item. Each NFT has a set of digital attributes and being cryptographically linked with respective event or item. Further, the NFT directly unlocks access related to the specific event or item.

A computer-implement system and method for purchasing a non-fungible token (NFT) of a specific event or item is disclosed. The system comprises a processor and a memory unit to store a set of instructions executable by the processor, a database to store a plurality of data associated with the customized NFT, and a user device to provide a digital marketplace that provides graphical user interface. The system sells NFTs related to specific events or items in real-time. The NFTs act as an access pass or voucher. The system directs the customer towards an NFT marketplace via a QR code or an inaudible tone, where the customer purchases or sells the NFT to provide access to the specific event or item. Each NFT has a set of digital attributes and being cryptographically linked with respective event or item. Further, the NFT directly unlocks access related to the specific event or item.

### BACKGROUND OF THE INVENTION

### Technical Field

The invention relates to the field of non-interchangeable units of data stored on a blockchain, and more particularly, to a computer-implemented system executed in a network environment for purchasing a customized non-fungible token (NFT) of a specific event or item in real-time.

The purchase or sale of NFTs is known in the art.

US20200273048 A1 describes cryptographic digital assets for retail products, methods for making/using such cryptographic digital assets, and computing systems for generating, intermingling, and exchanging blockchain-protected products. A method for provisioning cryptographic digital assets associated with retail product transfers includes broadcasting notifications of a future transaction of a retail product, and receiving, over a distributed computing network from the computing devices of multiple users, requests to participate in the transaction. A select number of users are added to a virtual line associated with the retail product transaction; from the virtual line, a first user is selected to receive the retail product and a second user is selected to receive a cryptographic digital asset containing a digital retail product and a unique digital asset code. The cryptographic digital asset is transferred to the second user's digital wallet, and the unique digital asset code is recorded on a record block of a blockchain ledger.

US20210326857 A1 describes methods for executing a smart contract that facilitates the electronic transfer of non-fungible tokens to a user according to a recipe. Each respective non-fungible token may be cryptographically linked with a digital representation of a respective asset that can be won by the user. A recipe may define a respective probability that the respective non-fungible token is awarded to the user and a manner by which the respective non-fungible token is awarded to the user. A smart contract may be generated using a random number and one of the non-fungible tokens selected based on the random number and the recipe and transferred to a digital wallet of the user.

US20210119807 A1 describes systems and methods to migrate a blockchain account. A blockchain migrate transaction can migrate an existing account from an old address to a new address. A blockchain account migration can be performed in response to a determination that a secret key associated with an address has or has potentially been exposed. Existing digital assets associated with a potentially compromised account may be carried over to a new account as part of a blockchain account migrate transaction.

Although the existing prior art disclose various systems and methods for generating NFTs, and various systems that use NFTs in blockchain for purchasing products, none of them disclose a system for purchasing or selling a customized NFT of a specific event or item and unlocking the access of the specific event or item using customizable NFTs.

Therefore, a need exists to improve over the prior art and more particularly, for a system and method for purchasing a customized non-fungible token (NFT) of a specific event or item. Also, there is a need for a system that unlocks access to specific events or items using NFTs. Further, there is a need for a system that uses an NFT in a raffle or competition.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### SUMMARY

A System and Method for Purchasing Customized Non-Fungible Tokens is disclosed. This summary is provided to introduce a selection of disclosed concepts in a simplified form that are further described below in the Detailed Description including the drawings provided. This Summary is not intended to identify key features or essential features of the claimed subject matter, nor is this summary intended to be used to limit the claimed subject matter's scope.

In one embodiment, a computer-implemented system is executed in a network environment for purchasing a non-fungible token (NFT) of a specific event or item, according to one embodiment of the present invention. In one embodiment, the system is designed for selling non-fungible tokens in real-time. In one embodiment, the NFTs are used in competitions or raffles to win the events.

In one embodiment, the network environment comprises one or more user devices and an NFT management system. Each user device is associated with a user. In one embodiment, the user device is configured to provide a digital marketplace that provides a graphical user interface. In one embodiment, the graphical user interface allows the user to transact for one or more items of the set of items from the user device. The user device is installed with the application software. In one embodiment, the user device enables the user to access one or more services provided by the system. In one embodiment, the user device communicates with the NFT management system via a communication network. In one embodiment, the user device is enabled to access the NFT management system via the network. In one embodiment, the user device is at least any one of a smartphone, a mobile phone, a tablet, a laptop, a desktop, and/or other suitable hand-held electronic communication devices. In one embodiment, the user device comprises a storage medium in communication with the network to access the NFT management system.

In one embodiment, the NFT management system comprises a server or computing device and one or more databases in communication with the computing device. In one embodiment, the computing device may be a cloud server. In one embodiment, the database is in communication with the computing device via the network. In one embodiment, the database is accessible by the server. In one embodiment, the computing device comprises a processor and computer-readable medium or memory unit operatively coupled to the processor. The memory unit stores a set of instructions executable by the processor configured to purchase or sell the customized non-fungible token (NFT) in real-time.

In one embodiment, the system performs tokenization or sells NFTs related to a specific event or item. In one embodiment, the NFTs are sold in real-time at events. The events may include concerts, sporting events, festivals, political rallies, etc. In one embodiment, the NFTs are customized non-fungible tokens (NFTs) that act as an access pass or voucher to permit the purchase of a specific item by the customer. In one embodiment, the purchase may be made using cryptocurrency, digital assets, and other traditional forms of payment including credit cards, debit cards, Apple/Google Pay, etc. In one embodiment, the system directs the customer or user, or purchaser toward an NFT marketplace via a QR code or an inaudible tone at a live event. In one embodiment, the QR code or inaudible tone may be received in person, during televised broadcasts, websites, and apps.

In one embodiment, the customer purchases or sells the NFT to provide access to a specific event or item. Each NFT has a set of digital attributes and being cryptographically linked with a respective event or item of a set of events and items. In one embodiment, the NFT either directly unlocks access related to the specific event or item. In one embodiment, the NFTs permit purchasers such as backstage passes, after parties, front row seats, locker room access, enter them in competitions or raffles related to the event, etc. Further, the NFT enters the user into a raffle or competition to win access.

In one embodiment, the system further comprises a blockchain configured to store the customized non-fungible token (NFT) received over the communication network. In one embodiment, the system further allows the user to burn or trade-in NFTs in exchange for an upgrade. In one embodiment, the burning NFTs permanently remove the token stored on a blockchain from circulation. The burning NFTs eliminates unsold or problematic inventory from an NFT drop. In one embodiment, the burning NFTs engage users through upgrades that replace an original NFT with a new NFT.

In one embodiment, the method for purchasing a customized non-fungible token (NFT) of a specific event or item is disclosed. In one embodiment, the method comprises a system having at least one processor and a memory unit operatively connected to at least one processor configured to store a set of instructions executable by the at least one processor, a database in communication with at least one processor via a communication network configured to store a plurality of data associated with the customized NFT, and a user device associated with a user-configured to provide a digital marketplace that provides a graphical user interface, where the graphical user interface allows the user to transact for one or more items of the set of items from the user device.

In one embodiment, the method includes the following steps. At another step, the tokenization of a pass/voucher is converted into customized non-fungible tokens (NFTs) related to the specific event or item. In one embodiment, the NFT acts as an access pass configured to permit the user to the backstage in a live event or locker room access. The events may include concerts, sporting events, festivals, political rallies, etc. At another step, a customer, user, or purchaser is directed towards the NFT marketplace via a QR code or an inaudible tone. In one embodiment, the QR code or inaudible tone may be received in person, during televised broadcasts, websites, and apps.

At another step, the NFT is purchased or sold to provide access to the specific event or item. In one embodiment, each NFT has a set of digital attributes and being cryptographically linked with a respective event or item of a set of events and items. In one embodiment, the purchase may be made using cryptocurrency, digital assets, and other traditional forms of payment including credit cards, debit cards, Apple/Google Pay, etc. At another step, the access related to the specific event or item is unlocked. In one embodiment, the NFT directly unlocks the access related to the specific event and item.

In one embodiment, the NFT enters the user into a raffle or competition to win access. In one embodiment, the user is allowed to burn (trade in) NFTs in exchange of upgrades. In one embodiment, the burning NFTs permanently removes the token stored on a blockchain from circulation. In one embodiment, the burning NFTs eliminates unsold or problematic inventory from an NFT drop. In one embodiment, the burning NFTs engage users through upgrades that replace an original NFT with a new NFT.

Other systems, methods, features and advantages of the invention will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 shows a computer-implemented system executed in a network environment for purchasing non-fungible tokens for a specific event or item, according to an example embodiment of the present invention.

FIG. 2 shows a method for purchasing non-fungible tokens for a specific event or item in one embodiment of the present invention, according to an example embodiment of the present invention.

### DETAILED DESCRIPTION OF THE PREFERRED EMBODIMENTS

The following detailed description refers to the accompanying drawings. Whenever possible, the same reference numbers are used in the drawings and the following description to refer to the same or similar elements. While disclosed embodiments may be described, modifications, adaptations, and other implementations are possible. For example, substitutions, additions or modifications may be made to the elements illustrated in the drawings, and the methods described herein may be modified by substituting reordering or adding additional stages or components to the disclosed methods and devices. Accordingly, the following detailed description does not limit the disclosed embodiments. Instead, the proper scope of the disclosed embodiments is defined by the appended claims.

The elements in the Figures interoperate as explained in more detail below. Before setting forth the detail explanation, however, it is noted that all of the discussion below, regardless of the particular implementation being described, is exemplary in nature, rather than limiting. For example, although selected aspects, features, or components of the implementations are depicted as being stored in memories, all or part of systems and methods consistent with the display systems may be stored on, distributed across, or read from other machine-readable media, for example, secondary storage devices such as hard disks, floppy disks, and CD-ROMs; a signal received from a network; or other forms of ROM or RAM either currently known or later developed.

In the description the term “server” refers to a general-purpose or special-purpose computer, generally including memory, input/output circuitry, and instruction processing logic along with interconnections such as one or more high-speed data buses connecting those components together. Many aspects of the disclosed techniques can be embodied as one or more server computers executing software. Similarly, a “client” herein is a computerized device (also including the above components and executing software) capable of receiving content from a network connection and decoding and rendering the content on a display or similar output device. So-called smartphones are specifically included within the definition of client as used herein.

Furthermore, although specific components of the architecture will be described, methods, systems, and articles of manufacture consistent with the architecture may include additional or different components. For example, a processor may be implemented as a microprocessor, microcontroller, application specific integrated circuit (ASIC), discrete logic, or a combination of other type of circuits or logic. Similarly, memories, may be DRAM, SRAM, Flash, or any other type of memory. Flags, data, databases, tables, and other data structures may be separately stored and managed, may be incorporated into a single memory or database, may be distributed, or may be logically and physically organized in many different ways. Programs may be parts of a single program, separate programs, or distributed across several memories and processors.

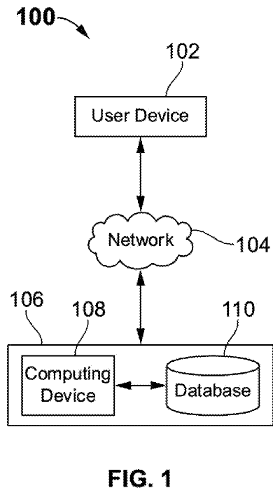

Referring now to the Figures, FIG. 1 shows a computer-implemented system executed in a network environment 100 for purchasing a non-fungible token (NFT) of a specific event or item, according to one embodiment of the present invention. In one embodiment, the system is designed for purchasing or selling of non-fungible tokens in real-time. In one embodiment, the NFTs are used in competitions or raffles to win the events.

In one embodiment, the network environment 100 comprises one or more user devices 102 and an NFT management system 106. Each user device is associated with a user. In one embodiment, the user device 102 is configured to provide a digital marketplace that provides a graphical user interface. In one embodiment, the graphical user interface allows the user to transact for one or more items of the set of items from the user device 102. In one embodiment, the user device 102 enables the user to access one or more services provided by the system. In one embodiment, the user device 102 communicates with the NFT management system 106 via a communication network 104. In one embodiment, the user device 102 is enabled to access the NFT management system 106 via network 104. In one embodiment, the user device 102 is at least any one of a smartphone, a mobile phone, a tablet, a laptop, a desktop, and/or other suitable hand-held electronic communication devices. In one embodiment, the user device 102 comprises a storage medium in communication with the network 104 to access the NFT management system 106. In an embodiment, the network 104 could be Wi-Fi, WiMAX, wireless local area network (WLAN), satellite networks, cellular networks, private networks, and the like.

In one embodiment, the NFT management system 106 comprises a server or computing device 108 and one or more databases 110 in communication with the computing device 108. In one embodiment, the computing device 108 may be a cloud server. In one embodiment, the computing device 108 may be operated as a single computer. In some embodiments, the computer may be a touchscreen and/or non-touchscreen and adopted to run on any type of OS, such as iOS™, Windows™, Android™, Unix™, Linux™, and/or others. In one embodiment, the plurality of computers is in communication with each other, via networks. Such communication is established via any one of an application software, a mobile application, a web application, a desktop application, a browser, an OS, and/or any combination thereof.

In one embodiment, the database 110 is in communication with the computing device 108 via the network 104. In one embodiment, the database 110 is accessible by the computing device 108. In another embodiment, the database 110 is integrated into the computing device 108 or separate from it. In some embodiments, the database 110 resides in a connected server or a cloud computing service. Regardless of location, the database 110 comprises a memory to store and organize certain data for use by the computing device 108. In one embodiment, the database 110 is in communication with at least one processor via a communication network configured to store a plurality of data associated with the customized NFT.

In one embodiment, the computing device 108 comprises at least one processor and computer-readable medium or memory unit operatively coupled to the processor. The memory unit stores a set of instructions executable by the processor configured to sell non-fungible tokens to the customers. The memory unit could be RAM, ROM (including EPROM, EEPROM, PROM). In one embodiment, the user devices 102 are configured to access the services provided by the computing device 108 via the network 104. In one embodiment, the computing device 108 is configured to provide a communication platform for purchasing NFT by the customers. In one embodiment, the communication network is associated with the memory configured to receive the customized non-fungible token (NFT).

In one embodiment, the system performs tokenization or sells NFTs related to a specific event or item. In one embodiment, the NFTs are sold in real-time at events. The events may include concerts, sporting events, festivals, political rallies, etc. In one embodiment, the NFTs are customized non-fungible tokens (NFTs) that act as an access pass or voucher to permit the purchase of a specific item by the customer. In one embodiment, the purchase may be made using cryptocurrency, digital assets, and other traditional forms of payment including credit cards, debit cards, Apple/Google Pay, etc. In one embodiment, the system directs the customer or user, or purchaser toward an NFT marketplace via a QR code or an inaudible tone at a live event. In one embodiment, the QR code or inaudible tone may be received in person, during televised broadcasts, websites, and apps. In one embodiment, the customer purchases or sells the NFT to provide access to a specific event or item. Each NFT has a set of digital attributes and being cryptographically linked with a respective event or item of a set of events and items. In one embodiment, the NFT either directly unlocks access related to the specific event or item. In one embodiment, the NFTs permit purchasers such as backstage passes, after parties, front row seats, locker room access, enter them in competitions or raffles related to the event, etc. Further, the NFT enters the user into a raffle or competition to win access.

In one embodiment, the system further comprises a blockchain configured to store the customized non-fungible token (NFT) received over the communication network. In one embodiment, the system further allows the user to burn (trade-in) NFTs in exchange for an upgrade. In one embodiment, the burning NFTs permanently remove the token stored on a blockchain from circulation. The burning NFTs eliminates unsold or problematic inventory from an NFT drop. In one embodiment, the burning NFTs engage users through upgrades that replace an original NFT with a new NFT.

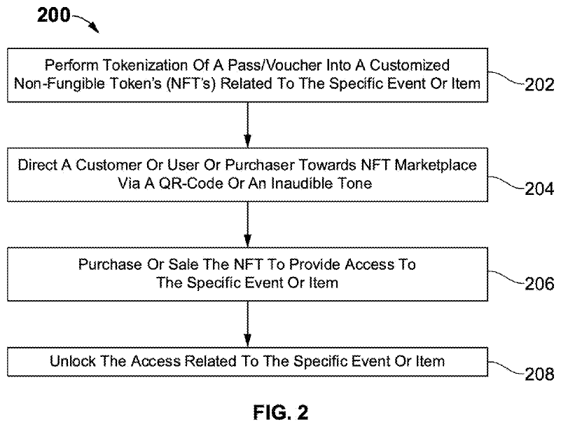

FIG. 2 shows a flow chart 200 of a method for purchasing a customized non-fungible token (NFT) of a specific event or item, according to one embodiment. In one embodiment, the method 200 includes a system comprising at least one processor and a memory unit operatively connected to the at least one processor configured to store a set of instructions executable by the at least one processor, a database in communication with at least one processor via a communication network configured to store a plurality of data associated with the customized NFT, and a user device associated with a user-configured to provide a digital marketplace that provides a graphical user interface, where the graphical user interface allows the user to transact for one or more items of the set of items from the user device.

In one embodiment, the method includes the following steps. At step 202, the tokenization of a pass/voucher is performed into customized non-fungible tokens (NFTs) related to the specific event or item. In one embodiment, the NFT acts as an access pass configured to permit the user to the backstage in a live event or locker room access. The events may include concerts, sporting events, festivals, political rallies, etc. At step 204, a customer, user, or purchaser is directed towards the NFT marketplace via a QR code or an inaudible tone. In one embodiment, the QR code or inaudible tone may be received in person, during televised broadcasts, websites, and apps.

At step 206, the NFT is purchased or sold to provide access to the specific event or item. In one embodiment, each NFT has a set of digital attributes and being cryptographically linked with a respective event or item of a set of events and items. In one embodiment, the purchase may be made using cryptocurrency, digital assets, and other traditional forms of payment including credit cards, debit cards, Apple/Google Pay, etc. At step 208, the access related to the specific event or item is unlocked. In one embodiment, the NFT directly unlocks the access related to the specific event and item.

In one embodiment, the NFT enters the user into a raffle or competition to win access. In one embodiment, the user is allowed to burn (trade in) NFTs in exchange of upgrades. In one embodiment, the burning NFTs permanently removes the token stored on a blockchain from circulation. In one embodiment, the burning NFTs eliminates unsold or problematic inventory from an NFT drop. In one embodiment, the burning NFTs engage users through upgrades that replace an original NFT with a new NFT.

The sequence diagram in FIG. 2 may be encoded in a signal bearing medium, a computer readable medium such as a memory, programmed within a device such as one or more integrated circuits, or processed by a controller or a computer. If the methods are performed by software, the software may reside in a memory resident to or interfaced to the any type of non-volatile or volatile memory interfaced or resident to the memory incorporated in the components in the network environment 100. Such memory may include an ordered listing of executable instructions for implementing logical functions. A logical function may be implemented through digital circuitry, through source code, through analog circuitry, or through an analog source such through an analog electrical, audio, or video signal. The software may be embodied in any computer-readable or signal-bearing medium, for use by, or in connection with an instruction executable system, apparatus, or device. Such a system may include a computer-based system, a processor-containing system, or another system that may selectively fetch instructions from an instruction executable system, apparatus, or device that may also execute instructions.

A “computer-readable medium,” “machine-readable medium,” “propagated-signal” medium, and/or “signal-bearing medium” may comprise any means that contains, stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM” (electronic), a Read-Only Memory “ROM” (electronic), an Erasable Programmable Read-Only Memory (EPROM or Flash memory) (electronic), or an optical fiber (optical). A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

While various embodiments of the invention have been described, including the best mode known to the inventors for carrying out the invention, it will be apparent to those of ordinary skill in the art that many more embodiments and implementations are possible within the scope of the invention. Accordingly, the invention is not to be restricted except in light of the attached claims and their equivalents.

What is claimed is:

1. A computer-implemented system executed in a network environment for purchasing a customized non-fungible token (NFT) of a specific event or item, comprising:
at least one processor and a memory unit operatively connected to the at least one processor configured to store a set of instructions executable by the at least one processor;
one or more databases in communication with the at least one processor via a communication network configured to store a plurality of data associated with the customized NFT, where the communication network is associated with the memory configured to receive the customized non-fungible token (NFT); and
a user device associated with a user configured to provide a digital marketplace that provides a graphical user interface, where the graphical user interface allows the user to transact for one or more items of the set of items from the user device,
where the processor is configured to:
perform tokenization of a pass/voucher into a customized non-fungible token's (NFT's) related to the specific event or item;
direct a customer or user or purchaser towards NFT marketplace via a QR-code or an inaudible tone;
purchase or sale the NFT to provide access to the specific event or item, and unlock the access related to the specific event or item.

2. The system of claim 1, further comprising a blockchain configured to store the customized non-fungible token (NFT) received over the communication network.

3. The system of claim 1, where each NFT comprises a set of digital attributes and being cryptographically linked with a respective event or item of a set of events and items.

4. The system of claim 1, where the NFTs are sold in real-time at events including concerts, sporting events, festivals or political rallies.

5. The system of claim 1, where the QR code or inaudible tone is received in person, during televised broadcasts, websites and apps.

6. The system of claim 1, where the NFT comprises an access pass configured to permit the user to the backstage in a live event or locker room access.

7. The system of claim 1, where the NFT is configured to directly unlock the access related to the specific event and item.

8. The system of claim 1, where the NFT is configured to enter the user into a raffle or competition to win access.

9. The system of claim 1, where the system is configured to allow the user to burn or trade in one or more NFTs in an exchange of upgrades.

10. The system of claim 9, where the burning or trading in one or more NFTs permanently removes the token stored on a blockchain from circulation.

11. The system of claim 9, where the burning or trading in one or more NFTs eliminates unsold or problematic inventory from an NFT drop.

12. The system of claim 9, where the burning or trading in NFTs engages users through upgrades that replace an original NFT with a new NFT.

13. A method for purchasing a customized non-fungible token (NFT) of a specific event or item using a computer-implemented system comprising at least one processor and a memory unit operatively connected to at least one processor configured to store a set of instructions executable by at least one processor, a database in communication with at least one processor via a communication network configured to store a plurality of data associated with the customized NFT, and a user device associated with a user configured to provide a digital marketplace that provides a graphical user interface, where the graphical user interface allows the user to transact for one or more items of the set of items from the user device, where the method comprises:
performing tokenization of a pass/voucher into a customized non-fungible token's (NFT's) related to the specific event or item;
directing a customer or user or purchaser towards NFT marketplace via a QR-code or an inaudible tone;
purchasing or selling the NFT to provide access to the specific event or item, where each NFT has a set of digital attributes and being cryptographically linked with a respective event or item of a set of events and items, and unlocking the access related to the specific event or item.

14. The method of claim 13, where the NFT comprises an access pass configured to permit the user to the backstage in a live event or locker room access.

15. The method of claim 13, where the NFT is configured to directly unlock the access related to the specific event and item.

16. The method of claim 13, where the NFT is configured to enter the user into a raffle or competition to win access.

17. The method of claim 13, further comprising allowing the user to burn or trade in NFTs in exchange of upgrades.

18. The method of claim 13, where the burning or trading in of NFTs permanently removes the token stored on a blockchain from circulation.

19. The method of claim 13, where the burning or trading in of NFTs eliminates unsold or problematic inventory from an NFT drop.

20. The method of claim 13, where the burning NFTs engage users through upgrades that replace an original NFT with a new NFT.
